(19) United States
(12) Patent Application Publication
(10) Pub. No.: US 2016/0364258 A1
(43) Pub. Date: Dec. 15, 2016

(54) METHOD FOR GENERATING UPGRADE CAMPAIGNS TO UPGRADE VIRTUALIZATION FACILITIES

(71) Applicants: Ekansh Singh KATIHAR, Montreal (CA); Maria TOEROE, Montreal (CA)

(72) Inventors: Ekansh Singh KATIHAR, Montreal (CA); Maria TOEROE, Montreal (CA)

(73) Assignee: TELEFONAKTIEBOLAGET LM ERICSSON (PUBL), Stockholm (SE)

(21) Appl. No.: 15/121,544

(22) PCT Filed: Mar. 6, 2014
(86) PCT No.: PCT/IB2014/059505

§ 371 Date: Aug. 25, 2016

(51) Int. Cl. G06F 9/455; G06F 9/445

(52) U.S. Cl. CPC G06F 9/45558; G06F 8/67; G06F 2009/4557

(57) ABSTRACT

An upgrade campaign is generated for runtime execution on a highly available system. The highly available system includes virtual machines (VMs) that are enabled for migration between virtual machine monitors (VMMs). VM migration is disabled for the VMs to be added, modified and removed in the upgrade campaign. A first set, a second set and a third set of sub-trees are identified from tree views of the source configuration and the target configuration. Each sub-tree contains entities representing a subset of the VMs and the VMMs. Each sub-tree of the first set includes entities tagged for addition only, each sub-tree of the second set includes entities tagged for modification, and each sub-tree of the third set includes entities tagged for removal only. An upgrade procedure is generated for each sub-tree, with an indication of the order of execution. Then VM migration is reenabled according to the target configuration.

### TECHNICAL FIELD

Embodiments of the invention relate to the upgrade of virtualization layers in the context of high availability. More specifically, embodiments of the invention relate to the generation of upgrade campaigns for upgrading the virtualization layers.

### BACKGROUND

The Service Availability (SA) Forum has defined the Software Management Framework (SMF) for orchestrating the upgrade of entities within a compliant system. SMF considers only the entities managed by the Availability Management Framework (AMF) and not the lower layers managed by the Platform Management Service (PLM). Consideration of the lower layers within the upgrade campaign allows a system to maintain high availability, such that compatibility among the different layers is maintained throughout the upgrade campaign. This is especially challenging in case of virtualization when virtual machines (VMs) can automatically migrate from one virtual machine monitor (VMM) to another to protect availability.

Some existing tools automate the management of an Information Technology (IT) infrastructure. However, these tools are not designed to address high availability of a system. These tools are not designed to address the coordination of the upgrade of different entities in a system such that the system services can be maintained during the upgrades. The automation of IT infrastructure management is addressed by the SA Forum SMF, which receives an input of an XML file specifying an upgrade campaign. Based on this input, SMF can then orchestrate the execution of the upgrade campaign. The key role that SMF plays is the coordination of the different upgrade steps according to the provided upgrade campaign so that the availability of services is not jeopardized.

However, the SA Forum SMF does not address the upgrade of lower layer entities. Existing tools that addresses the layered architecture of a single host machine fails to address the coordination of the upgrade of host machines that host migration-enabled VMs. Such VMs can be automatically migrated by the system to maintain high availability, which in the context of upgrade may result in incompatibility.

### SUMMARY

According to one embodiment, a method performed by a computer system is provided for generating an upgrade campaign for runtime execution on a highly available system. The highly available system includes VMs that are enabled for migration between VMMs. The method comprises the steps of: receiving a source configuration and a target configuration of the highly available system as input; generating a configuration change that disables migration of the VMs to be added, modified and removed in the upgrade campaign, wherein the migration is disabled when each of the VMs is anchored on a hosting VMM selected from the input; and identifying a first set, a second set and a third set of sub-trees from tree views of the source configuration and the target configuration. Each sub-tree contains entities representing a subset of the VMs and the VMMs. Each sub-tree of the first set includes entities tagged for addition only, each sub-tree of the second set includes entities tagged for modification, and each sub-tree of the third set includes entities tagged for removal only. The method further comprises the steps of: generating an upgrade procedure for each sub-tree of the first set, the second set and the third set, with an indication that upgrade procedures of the first set are to be executed first and upgrade procedures for the third set are to be executed last in the upgrade campaign; and generating another configuration change that re-enables the migration of the VMs according to the target configuration.

According to another embodiment, a computer system is provided to generate an upgrade campaign for runtime execution on a highly available system. The highly available system includes VMs that are enabled for migration between VMMs. The computer system comprises a memory to store a source configuration and a target configuration of the highly available system. The computer system further comprises one or more processors coupled to the memory. The one or more processors are adapted to: receive the source configuration and the target configuration as input; generate a configuration change that disables migration of the VMs to be added, modified and removed in the upgrade campaign, wherein the migration is disabled when each of the VMs is anchored on a hosting VMM selected from the input; and identify a first set, a second set and a third set of sub-trees from tree views of the source configuration and the target configuration. Each sub-tree contains entities representing a subset of the VMs and the VMMs. Each sub-tree of the first set includes entities tagged for addition only, each sub-tree of the second set includes entities tagged for modification, and each sub-tree of the third set includes entities tagged for removal only. The one or more processors are further adapted to: generate an upgrade procedure for each sub-tree of the first set, the second set and the third set, with an indication that upgrade procedures of the first set are to be executed first and upgrade procedures for the third set are to be executed last in the upgrade campaign; and generate another configuration change that re-enables the migration of the VMs according to the target configuration.

According to yet another embodiment, a system is provided for generating an upgrade campaign for runtime execution on a highly available system. The highly available system includes VMs that are enabled for migration between VMMs. The system comprises: a receiving module configured to receive a source configuration and a target configuration of the highly available system as input; a first configuration change generating module configured to generate a configuration change that disables migration of the VMs to be added, modified and removed in the upgrade campaign, wherein the migration is disabled when each of the VMs is anchored on a hosting VMM selected from the input; and an identifying module configured to identify a first set, a second set and a third set of sub-trees from tree views of the source configuration and the target configuration. Each sub-tree contains entities representing a subset of the VMs and the VMMs. Each sub-tree of the first set includes entities tagged for addition only, each sub-tree of the second set includes entities tagged for modification, and each sub-tree of the third set includes entities tagged for removal only. The system further comprises an upgrade procedure generating module configured to generate an upgrade procedure for each sub-tree of the first set, the second set and the third set, with an indication that upgrade procedures of the first set are to be executed first and upgrade procedures for the third set are to be executed last in the upgrade campaign; and a second configuration change generating module configured to generate another configuration change that re-enables the migration of the VMs according to the target configuration.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates an example of a source configuration according to one embodiment of the invention.

FIG. 2 illustrates an example of a target configuration according to one embodiment of the invention.

FIG. 3 illustrates an example of a system configuration after VMs are anchored to selected VMMs according to one embodiment of the invention.

FIG. 4 illustrates an example of a system configuration after execution of an addition upgrade procedure according to one embodiment of the invention.

FIG. 5 illustrates an example of a system configuration after execution of upgrade procedures according to one embodiment of the invention.

FIG. 6 is a flow diagram illustrating an overview of a method for creating an upgrade campaign according to one embodiment of the invention.

FIG. 7 illustrates an example of a tree view of the source configuration according to one embodiment of the invention.

FIG. 8 illustrates an example of a tree view of the target configuration according to one embodiment of the invention.

FIG. 9 illustrates an example of a tree view of the source configuration after pre-processing according to one embodiment of the invention.

FIG. 10 illustrates an example of a tree view of the target configuration after pre-processing according to one embodiment of the invention.

FIG. 11 is a flow diagram illustrating a method for generating upgrade procedures to add entities according to one embodiment of the invention.

FIG. 12 is a flow diagram illustrating a method for generating upgrade procedures to modify entities according to one embodiment of the invention.

FIG. 13 is a flow diagram illustrating a method for generating upgrade procedures to remove entities according to one embodiment of the invention.

FIG. 14 is a flow diagram illustrating a method for generating an upgrade campaign according to one embodiment of the invention.

FIG. 15 illustrates a diagrammatic representation of a system for generating an upgrade campaign according to one embodiment of the invention.

FIG. 16 illustrates a diagrammatic representation of a computer system according to one embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention generate upgrade campaigns for upgrading lower layers of a highly available system. The upgrade campaigns can be executed by an extension of SMF. The input to the upgrade campaign generation is the current (i.e., source) configuration and the target configuration of the lower layers of the system. The upgrade includes addition, modification, and/or removal of various entities of the system.

The term “lower layers” herein refers to all of the layers including and below the middleware defined in the SA Forum. Examples of a lower-layer entity include an operating system (OS), a virtual machine (VM), and a virtual machine monitor (VMM). When applying an upgrade to a lower layer, an upgrade campaign can be executed at runtime to perform version change, base type change, new installation, removal of an entity, among other actions.

The upgrade campaign generation described herein allows a controlled runtime upgrade of lower layers of a system so that high availability of the system is not jeopardized during the upgrade. While the upgrade campaign generation is presented in the context of the SA Forum specifications, the principles described herein can be applied to other systems or frameworks that support highly available services.

In one embodiment, the upgrade campaign generation includes three phases. To render the upgrade predictable and controllable, in the first phase the entities representing the VMs are caught (also referred to as “anchored” or “demobilized”) on selected VMMs; that is, VM migration is disabled. In the second phase entities are upgraded according to a schedule, which orders the execution of upgrade procedures in such a way that the upgrade causes no loss of service. In the last phase the VM migration is re-enabled according to the target configuration.

An example is provided below to explain how a system that supports VMMs and migration-enabled VMs is upgraded at runtime without loss of services provided by an application. In the example below, the suffixes of the names of the VMs and VMMs indicate the upgrade operation to be performed on them. Specifically, ‘-R’ indicates removal, ‘-A’ indicates addition and ‘-M’ indicates modification. Entities to be removed are present in the source configuration only, entities to be added are present in the target configuration only, and entities to be modified are present in both the source and target configurations under the same name.

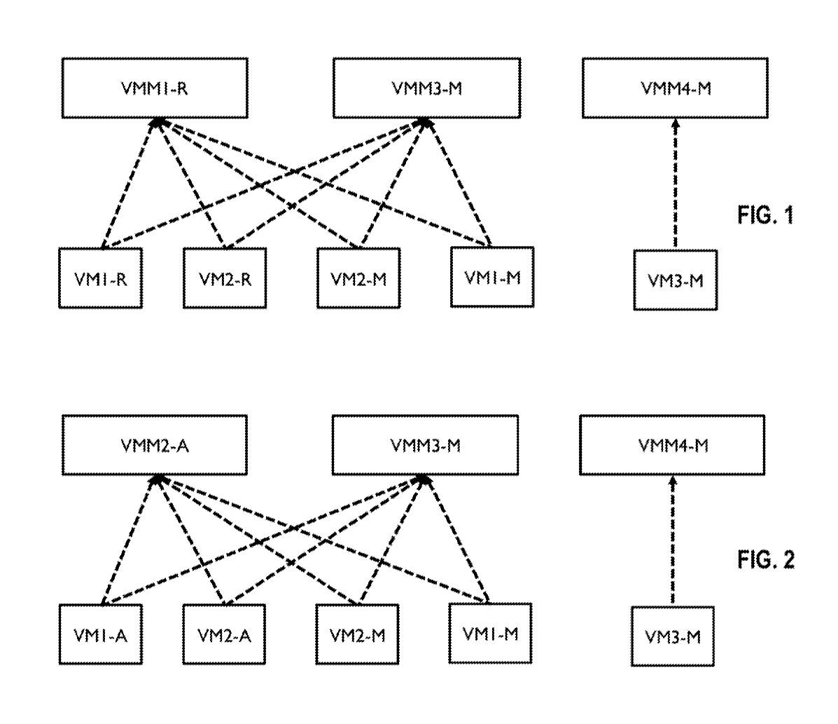

FIG. 1 illustrates an example of a source configuration of a system according to one embodiment. In this example, the source configuration includes five VMs and three VMMs. VM1-R and VM2-R are sponsored from VMM1-R, and VM1-M and VM2-M are sponsored from VMM3-M. VMM1-R and VMM1-M are the hosting entities, and the four VMs (VM1-R, VM2-R, VM1-M and VM2-M) are the hosted entities. These four VMs are migration enabled. Accordingly, if VMM1-R goes down for any reason (e.g., an administrative lock), the two VMs (VM1-R and VM2-R) hosted on VMM1-R are automatically migrated to VMM3-M, which is the other eligible hosting VMM for the two VMs in this example.

In one embodiment, application services provided by the system are configured in such a way that for all the application components hosted on VM1-R, VM2-R, VM1-M and VM2-M, there is a redundant application component present on VM3-M. It is understood that other VMs or VMMs may also exist in the system to provide redundancy but they are omitted for simplicity of the description.

In this example, it is assumed that the VMs that provide redundancy (and therefore protecting some other VMs at the application level) share no VMM with those protected VMs. Thus, VMM4-M sponsors VM3-M only. As VM3-M hosts all the redundant application components, VM3-M is not sponsored from any of VMM1-R and VMM1-M.

FIG. 2 illustrates an example of a target configuration for the system according to one embodiment. The target configuration removes VM1-R, VM2-R and VMM1-R; adds VM1-A, VM2-A and VMM2-A; and modifies the type of VM1-M, VM2-M, VM3-M and VMM3-M and VMM4-M. VM1-A, VM2-A, VM2-M and VM1-M can migrate between VMM2-A and VMM3-M. Redundant application components are distributed in a similar manner as in the source configuration of FIG. 1.

To prepare for the upgrade of the VMs, in the first phase the VMs are demobilized such that each VM resides on one VMM only. In one embodiment, the VMs' dependencies are modified such that each VM has only one hosting VMM. As a result, each VM is caught on a single VMM and cannot migrate even if that hosting VMM goes out of service. After the demobilization, the VMs and the hosting VMM can be upgraded using an upgrade step (e.g., an embedded upgrade step) and their compatibility can be maintained.

The process of capturing VMs on a single VMM is performed at the beginning of the upgrade campaign for the VMs that are to be removed or modified. VMs that are to be added to the system are not yet present at the beginning of the upgrade campaign, and, therefore, no demobilization is applied to these added VMs. When a VM is added during the upgrade, it is added with a single hosting VMM selected from any of its hosting VMMs present in the target configuration.

A VM that is to be removed or added can be caught on any of its eligible hosting VMMs; however, a VM that is to be modified can only be caught on a VMM that is also to be modified or remains unchanged in the upgrade. That is, modified VMs are not caught on the VMMs that are to be removed or added. This is because the VMMs that are to be removed or added are present only in one of the source and target configurations.

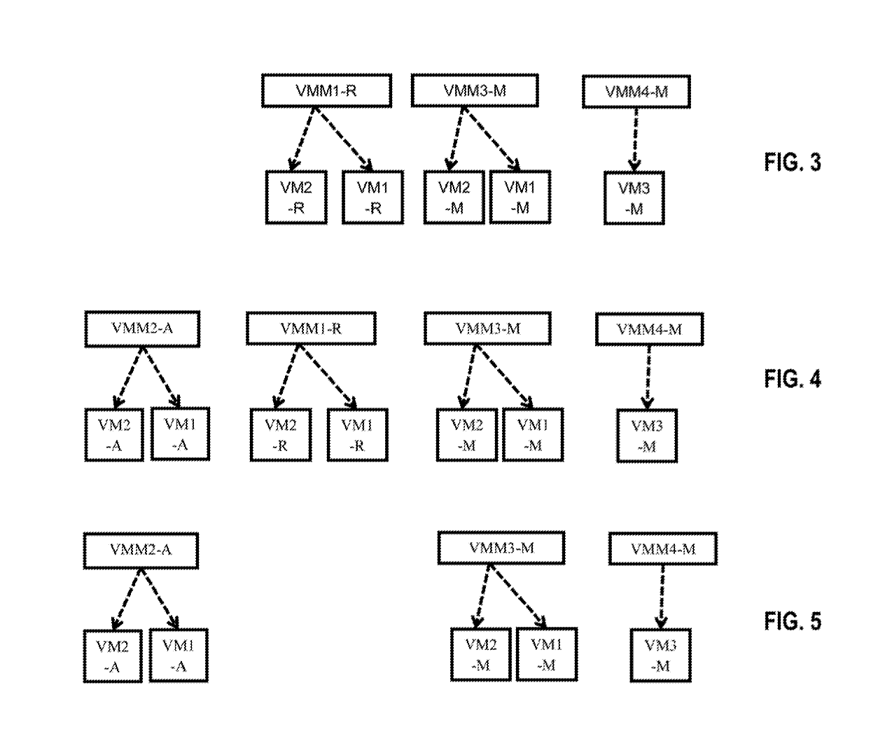

In this example VM2-M and VM1-M are caught on VMM3-M, all of which are to be modified. VMs that are to be removed (VM1-R, VM2-R) are caught on the VMM that is to be removed (VMM1-R). Catching the VMs transforms the source configuration to an intermediate configuration shown in the example of FIG. 3, according to one embodiment.

In the second phase the entities are upgraded according to the source and target configurations. The upgrade of different entities are scheduled such that the execution does not cause any application service outage, even in the special case when all VMs of the source configuration that host application components to provide a given service are removed from the system and replaced by VMs added by the target configuration that host the new application components for that same service. To avoid service outage, the execution of the addition of entities is scheduled first so that these added entities are already able to provide the services when the removal and modification of the entities of the source configuration are performed.

Accordingly, in the example configuration VM1-A, VM2-A and VMM2-A are added first. At this time the VMs are added with one hosting VMM (i.e., VMM2-A in this example). FIG. 4 illustrates the resulting configuration in this example after the addition of the VMs and VMM.

Next, modification and removal of the entities are performed. The modification of VMM4-M and VM3-M is performed before or after the modification of VMM3-M, VM1-M and VM2-M, but not in parallel. FIG. 5 illustrates the resulting configuration in this example after the removal and modification of the VMs and VMMs.

In the last phase the VM migration is re-enabled. The dependencies for the migration-enabled VM are modified according to the target configuration. In the example, the dependency objects of VM1-A and VM2-A are modified to be sponsored from VMM2-A, and the dependency objects of VM1-M and VM2-M are modified to be sponsored from VMM3-M. The result is the target configuration as shown in the example of FIG. 2.

To generate an upgrade campaign that specifies the three-phase execution described above, an upgrade campaign generator receives a source configuration and a target configuration as input. The source and target configurations are compared to identify the upgrade target (i.e., the entities to be added, removed or modified by the upgrade campaign). The configuration models are extended with the information and relations for the upgrade campaign generation. For each migration-enabled VM to be upgraded, an appropriate hosting VMM is selected for that VM. That is, each VM is caught on a single VMM and this relation is added to the tree view of the configuration.

The upgrade campaign generator generates an initialization section of the upgrade campaign. This section, when executed, performs a configuration change to modify the VM dependency information for the VMs to be removed and modified according to the VM-VMM relations set up previously.

Subsequently, the upgrade campaign generator generates the campaign body section as a collection of single-step upgrade procedures. First, a set of upgrade procedures for the added entities is generated. These upgrade procedures are set to one or more first execution levels (e.g., the lowest execution level) to indicate that they are to be executed first. These addition upgrade procedures may be executed in parallel or in sequence. Secondly, a set of upgrade procedures is generated for the modified entities and removed entities that are hosted on the modified entities. These upgrade procedures are set to sequential execution levels so that they are executed in sequence, starting after the completion of the addition upgrade procedures. Thirdly, a set of upgrade procedures for the remaining removed entities is generated. These upgrade procedures are set to execution levels higher than all of the previous upgrade procedures to indicate that they are to be executed last. They may be executed in parallel or in sequence.

Finally, the upgrade campaign generator generates a campaign wrap-up section. This section, when executed, performs a configuration change to modify VM dependencies such that the dependencies match the target configuration; that is, VM migration is re-enabled.

The “single-step upgrade procedure” as used herein can be a single upgrade step as defined by the SMF specification, or, alternatively, an embedded step. An upgrade step generally includes three phases that are executed in sequence: the tear-down phase (T), the reconfiguration phase (R) and the build-up phase (B). An upgrade step is completed when all three phases are completed. For example, in a rolling upgrade that includes three upgrade steps, each step will be executed to completion in sequence as: {T1, R1, B1}; {T2, R2, B2}; {T3, R3, B3}. An embedded step is different in that it reorders this execution sequence by nesting the upgrade steps. When nesting the steps, first the tear down phase of each nested step is executed, then the reconfiguration phase of each nested step is executed, and finally the build-up phase of each nested step is executed. So the three phases are still clearly separated and executed in sequence for the entire embedded step. In the above three-step example, the three nested steps of an embedded step will be executed in sequence as: {T1, T2, T3, R1, R2, R3, B3, B2, B1}. It is noted that the tear-down phases (T1, T2, T3) of the embedded step starts from the outer most nested step (T1) while the build-up phase (B3, B2, B 1) starts from the inner most nested step (B3). Thus, the “single-step upgrade procedure” herein can be a single upgrade step (e.g., {T, R, B}) or, alternatively, an embedded step that includes any number of nested steps (e.g. {T1, T2, . . . , Tn, R1, R2, Rn, Bn, . . . , B2, B1}.

In one embodiment, the upgrade campaign generator is part of the system that executes the upgrade campaign. In an alternative embodiment, the upgrade campaign generator resides in a system different from the system executing the upgrade campaign. Further, a system may start executing an upgrade campaign after the generation of the upgrade campaign is completed, or while the upgrade campaign is being generated.

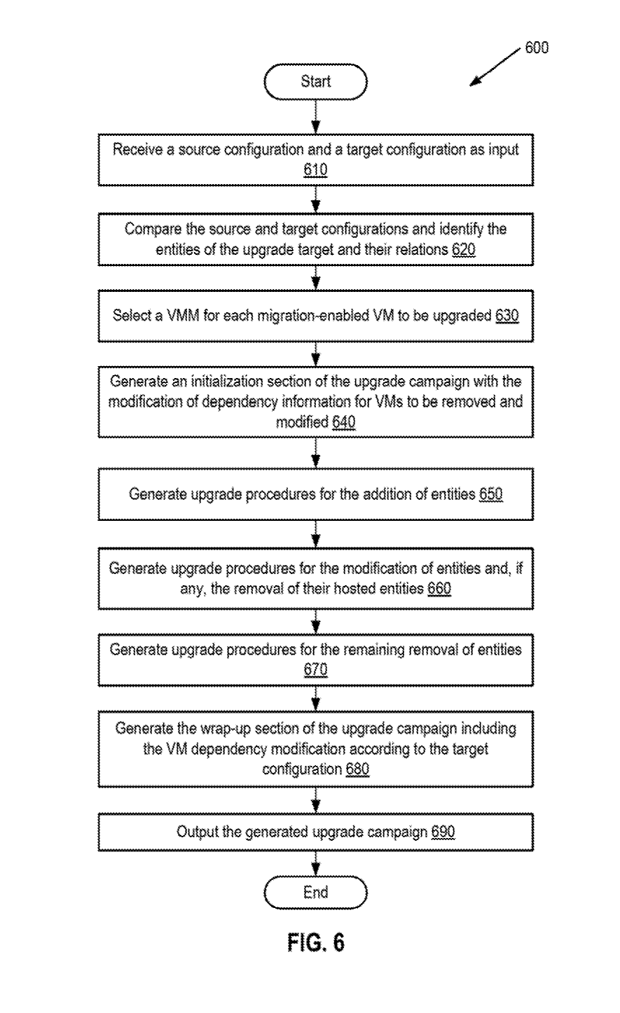

FIG. 6 is a flow diagram illustrating an overview of an approach for generating an upgrade campaign according to one embodiment. First, the source and target configurations are received as input (610). The source and target configurations are compared, and entities of the upgrade target and their relations are identified (620). In one embodiment, the source and target configurations are instances of the PLM information model. Each PLM configuration has a PLM Domain object at its root. The entities of concern represented in the model are the execution environment (EE) entities. In a PLM information model, EE entities are represented as direct or indirect child objects of the PLM Domain object. EEs may be used to represent VMs and VMMs. Moreover, EEs may have dependency relations associating the migration-enabled VMs with the VMMs eligible for hosting the VMs. To facilitate the upgrade campaign generation, new associations are set up between these configuration objects of the PLM information model. For each of the configurations (i.e., source and target), from the root (i.e., the Domain object) a direct link is set to each EE hosted directly on a hardware element. Each of the EEs in the configuration is also directly linked to the EE hosting or potentially hosting that EE.

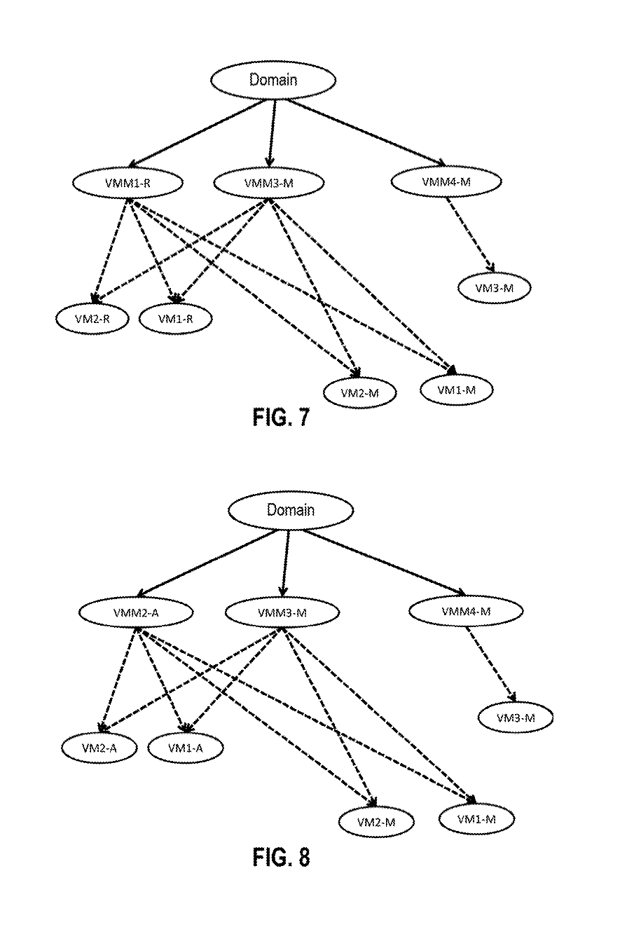

FIG. 7 and FIG. 8 illustrate the corresponding tree views of the source and target configurations of FIG. 1 and FIG. 2 according to one embodiment. The potential hosts are derived from the dependency relation of the EEs and marked by dotted lines in the figures, while the hosting relation follows the parent-child relation of EEs in the PLM configuration.

To identify the upgrade operation for each EE in the system, these tree views of the source and target configurations are compared using the distinguished names (DN) of the EEs as the basis. If a DN of an EE is found in the source configuration but not in the target configuration, that EE is tagged for the REMOVAL operation in the source configuration (as indicated by the suffix ‘It’ in the EE's name). If a DN of an EE is found in the target configuration, but not in the source configuration, that EE is tagged for the ADDITION operation in the target configuration (as indicated by the suffix ‘A’ in the EE's name). If a DN of an EE is found in both the source configuration and the target configuration, then the objects in the PLM information model that represent the EE before and after the upgrade are compared. More specifically, the values of all of the attributes of the object in the source configuration and the object in target configuration are compared. If the attribute values in the source configuration and the target configuration are same, the EE is tagged for NO-OPERATION. Otherwise, it is tagged for the MODIFY operation in both configurations (as indicated by the suffix ‘M’ in the EE's name).

Referring again to FIG. 6, after setting up the tree views corresponding to the configurations, a single hosting VMM is selected for each migration-enabled VM that is to be upgraded (630). In the tree views, migration-enabled VMs are represented by the EEs, which are connected with dotted lines to one or more potential hosting EEs. If an EE is tagged for REMOVAL, one of its potential hosting EEs from the source configuration is selected and the links to all other potential hosting EEs are removed. In this scenario, the selection preference is given to EEs that are also tagged for REMOVAL. If an EE is tagged for ADDITION, one of its potential hosting EEs from the target configuration is selected and the links to all other potential hosting EEs are removed. In this scenario, the potential hosting EEs tagged for ADDITION are most preferred while the EEs tagged for MODIFY are least preferred for the selection. If an EE is tagged for MODIFY, one of its potential hosting EEs tagged for MODIFY or NO-OPERATION is selected, and the links to all other potential hosting EEs are removed in both the source and target configurations.

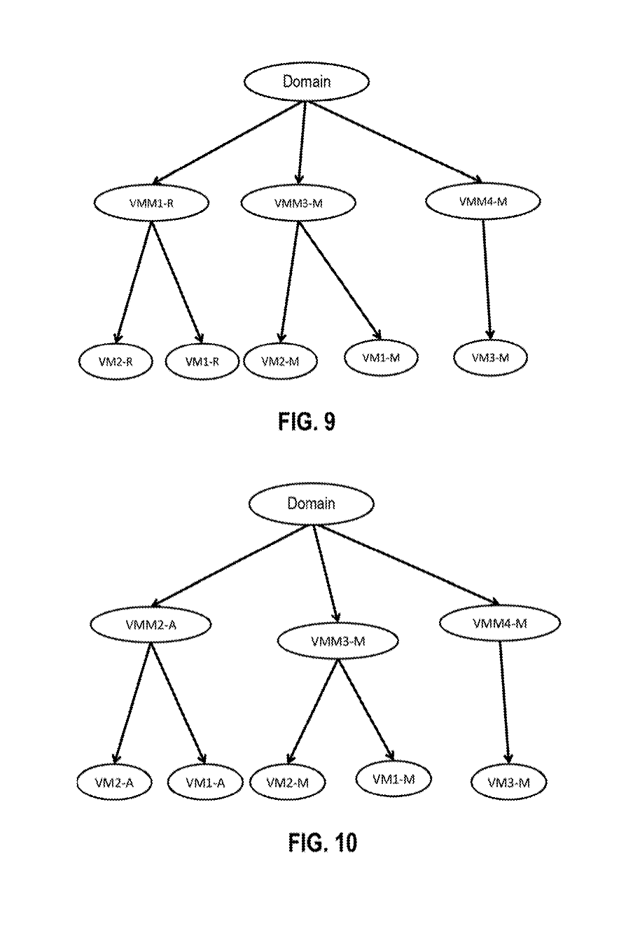

FIG. 9 and FIG. 10 illustrate an example of tree views of the source and target configurations, as a result of the pre-processing step of selecting the hosting EEs. The upgrade campaign generation proceeds as follows.

Referring again to FIG. 6, a campaign initialization section is generated (640), which includes the modifications of the dependencies of EEs representing VMs so that they are anchored on the VMMs that are selected for each of the VMs. For this purpose, the tree view of the source configuration is traversed and a modification operation is generated for the dependency object of each EE that represents a VM tagged for REMOVAL or MODIFY, such that the dependency object contain only the selected hosting EE (i.e., a single hosting VMM). The dependency object is a child object of a PLM entity object in the PLM configuration, which lists all the PLM entities on which the given PLM entity depends on and the number of them to be in-service for the dependency to be satisfied. For a VM, this dependency object is used to indicate on which VMMs that VM can be hosted, and at least one of them needs to be in service to satisfy the dependency; i.e., to host the VM.

Subsequently, upgrade procedures are generated for the addition of entities (650), modification of entities and removal of their hosted entities (if any) (660), and the remaining removal of entities (670).

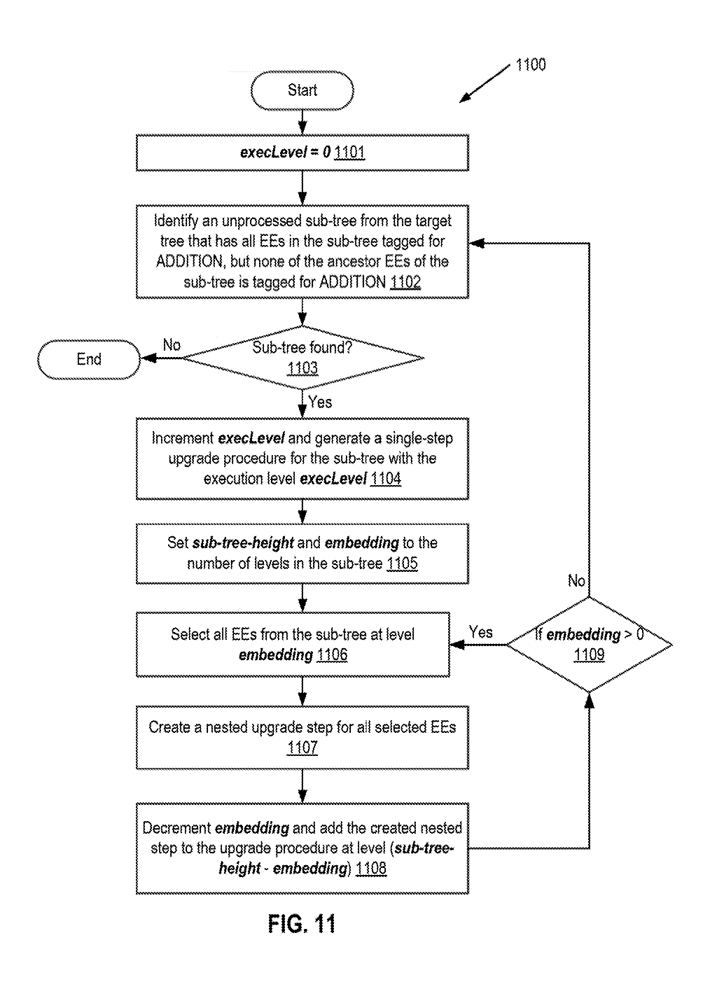

FIG. 11 is a flow diagram illustrating a method 1100 for generating upgrade procedures to add entities, according to one embodiment. Initially, the execution level (execLevel) is set to zero (1101). In this example, an upgrade procedure with a lower execution level is executed before another upgrade procedure with a higher execution level. The tree view of the target configuration (i.e., the target tree) is traversed, and an unprocessed sub-tree is identified from the target tree such that all EEs of the sub-tree (also referred to as the “hosted EEs”) are tagged for ADDITION, but none of the hosting EEs (i.e., ancestor parent nodes) of the sub-tree are tagged for ADDITION (1102). The method 1100 continues if such a sub-tree is found (1103); otherwise, the method is terminated.

For each identified sub-tree, a single-step upgrade procedure is generated. In one embodiment, the execution level of the generated procedures is set to the lowest (e.g., execLevel=0) level for all of the EEs to be added. In an alternative embodiment, the execution level for each sub-tree is incremental, such that the upgrade of different sub-trees is executed sequentially (1104).

Within the single-step upgrade procedure, a separate nested step is generated for each layer of the hosted EEs using the information of the target configuration. Entities are in the same layer of a sub-tree if they have the same distance (i.e., the same number of hops) from the root of the sub-tree. Each of the nested steps includes a sequence of actions for upgrading a layer of the entities in the sub-trees. In one embodiment, sub-tree-height and embedding are set to be the number of levels in the sub-tree (1105), where embedding is used as a down-counter to keep track of the levels of sub-trees that have yet to be processed. All the EEs at the embedding level are selected (1106), and a nested step is created for all of the selected EEs at that embedding level (1107). Then embedding is decremented, and the nested step is added to the upgrade procedure for the sub-tree at the level of (sub-tree-height—embedding) (1108). The operations of blocks 1106-1108 are repeated until embedding reaches zero (1109), at which point the next unprocessed sub-tree (if any) is identified and processed. When all of the sub-trees for ADDITION are processed, the method 1100 is terminated.

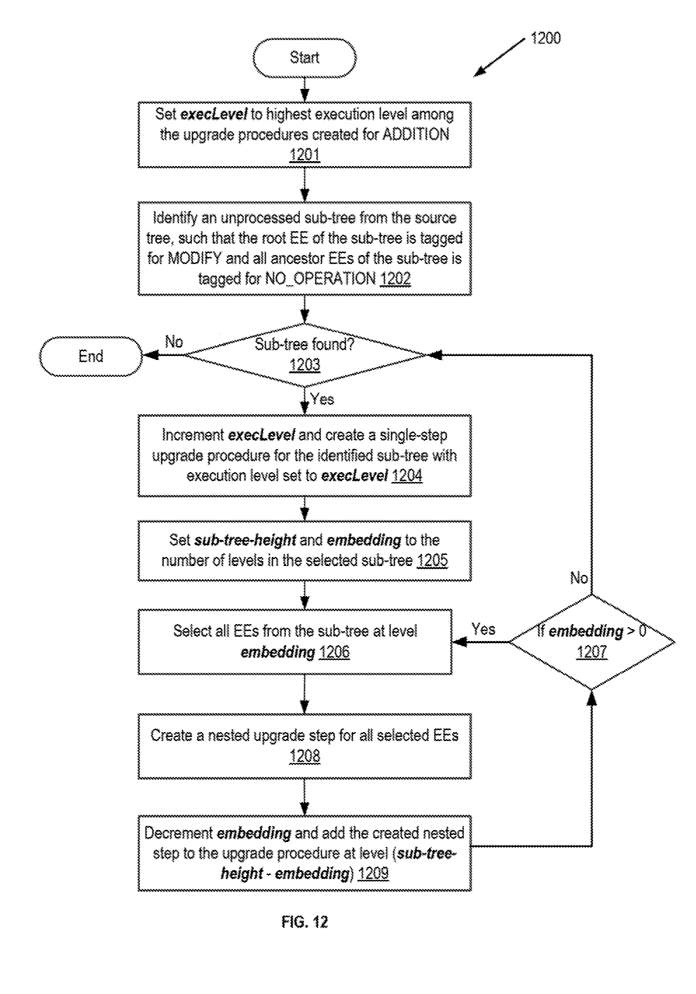

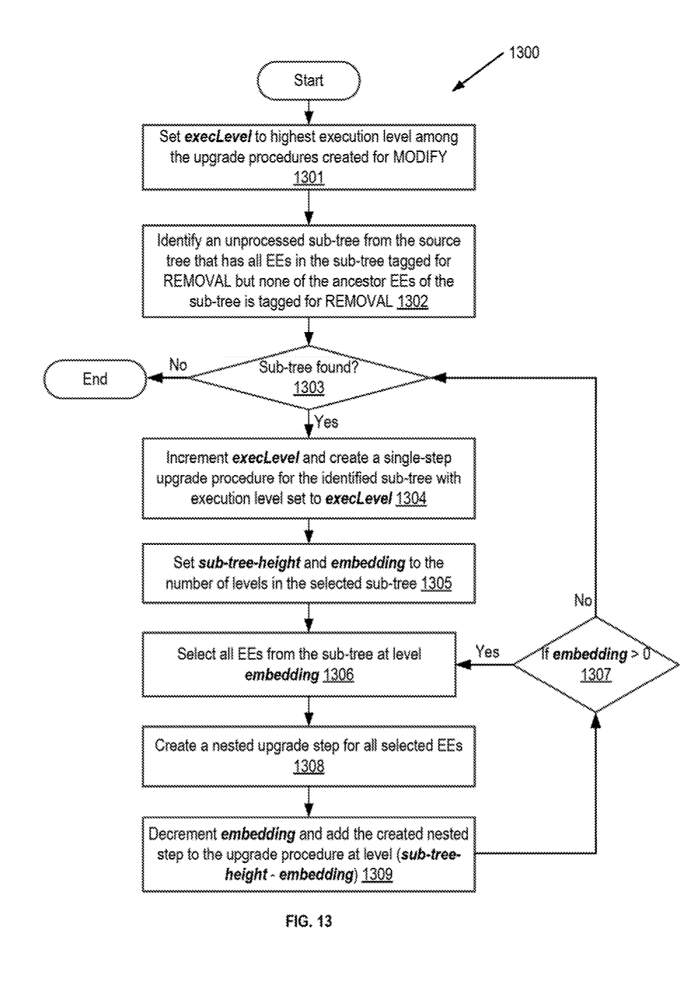

FIG. 12 is a flow diagram illustrating a method 1200 for generating upgrade procedures for entities to be modified, according to one embodiment. Initially, the execution level (execLevel) is set to the highest execution level among the upgrade procedures created for ADDITION (1201). The tree view of the source configuration (i.e., the source tree) is traversed, and an unprocessed sub-tree is identified from the source tree such that the root EE of each sub-tree is tagged for MODIFY, and all ancestor parent nodes of the sub-tree are tagged for NO-OPERATION up to the Domain object (1202). Within the sub-tree, the EEs may be tagged for MODIFY, REMOVAL, NO-OPERATION, or any combination of MODIFY, REMOVAL and NO-OPERATION. The method 1200 continues if such a sub-tree is found (1203); otherwise, the method is terminated.

For each identified sub-tree, a single-step upgrade procedure is generated. In one embodiment, the execution level for each sub-tree is incremental, such that the upgrade of different sub-trees is executed sequentially (1204).

Within the single-step upgrade procedure, a separate nested step is generated for each layer of the hosted EEs. Each of the nested steps includes a sequence of actions for upgrading a layer of the entities in the sub-trees. For each nested step, the entities taken out of service are the selected EEs in the source configuration, while the entities put back to service are the remaining equivalent entities in the target configuration. The execution level of the upgrade procedures created for the different sub-trees is incrementally increased so that these upgrade procedures will be executed in sequence. The sequential execution ensures that redundant entities are not taken out of service simultaneously.

In one embodiment, sub-tree-height and embedding are set to be the number of levels in the sub-tree (1205), where embedding is used as a down-counter to keep track of the levels of sub-trees that have yet to be processed. All the EEs at the embedding level are selected (1206), and a nested step is created for all of the selected EEs at that embedding level (1207). Then embedding is decremented, and the nested step is added to the upgrade procedure for the sub-tree at the level of (sub-tree-height—embedding) (1208). The operations of blocks 1206-1208 are repeated until embedding reaches zero (1209), at which point the next unprocessed sub-tree (if any) is identified and processed. When all of the sub-trees for MODIFY are processed, the method 1200 is terminated.

FIG. 13 is a flow diagram illustrating a method 1300 for generating upgrade procedures for entities to be modified, according to one embodiment. Initially, the execution level (execLevel) is set to the highest execution level among the upgrade procedures created for MODIFY (1301). The source tree is traversed, and an unprocessed sub-tree is identified from the source tree such that all EEs of each sub-tree are tagged for REMOVAL, and none of the hosting EEs (i.e., ancestor parent nodes) of the sub-tree are tagged for REMOVAL. The method 1300 continues if such a sub-tree is found (1303); otherwise, the method is terminated.

For each identified sub-tree, a single-step upgrade procedure is generated. The execution level of the generated procedures is equal to or higher than the execution levels of the upgrade procedures generated for the MODIFY operation. In one embodiment, the execution level of the generated procedures is set to the maximum level for all of the EEs to be removed. In an alternative embodiment, the execution level for each sub-tree is incremental, such that the upgrade of different sub-trees is executed sequentially (1304).

Within the single-step upgrade procedure, a separate nested step is generated for each layer of the hosted EEs using the information of the source configuration. Each of the nested steps includes a sequence of actions for upgrading a layer of the entities in the sub-trees. In one embodiment, sub-tree-height and embedding are set to be the number of levels in the sub-tree (1305), where embedding is used as a down-counter to keep track of the levels of sub-trees that have yet to be processed. All the EEs at the embedding level are selected (1306), and a nested step is created for all of the selected EEs at that embedding level (1307). Then embedding is decremented, and the nested step is added to the upgrade procedure for the sub-tree at the level of (sub-tree-height—embedding) (1308). The operations of blocks 1106-1108 are repeated until embedding reaches zero (1309), at which point the next unprocessed sub-tree (if any) is identified and processed. When all of the sub-trees for REMOVAL are processed, the method 1300 is terminated.

Referring again to FIG. 6, to complete the upgrade campaign generation, a campaign wrap-up section is generated to re-enable the migration of VMs according to the target configuration (680). For the campaign wrap-up section, the target tree is traversed and a modification operation is generated for the dependency object of each EE that represents a VM and is tagged for ADDITION or MODIFY. Thus, the dependency object contains the complete list of potential hosting EEs (i.e., all eligible VMMs) for the VM. Then the method 600 outputs the generated upgrade campaign and is terminated (690).

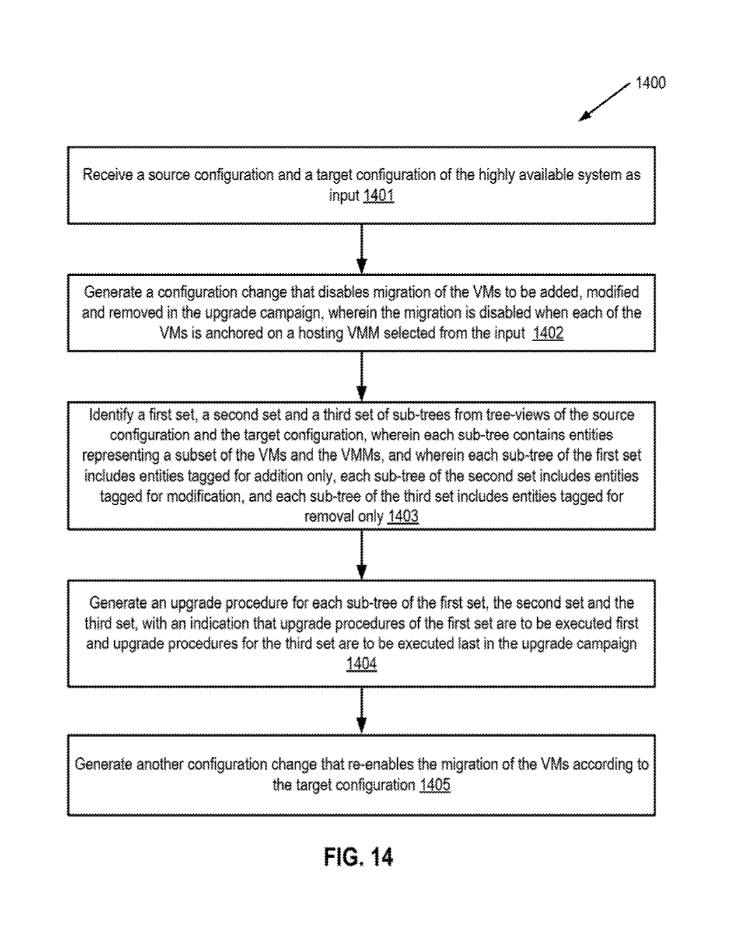

FIG. 14 is a flow diagram illustrating a method 1400 for generating an upgrade campaign for runtime execution on a highly available system according to one embodiment. “Runtime execution” means that the upgrade campaign is executed on the highly available system during runtime operation of the highly available system. The upgrade campaign may be generated offline or at runtime, and may be generated by the highly available system itself or by another system.

The highly available system (that is, the system that is to execute the resulting upgrade campaign) includes VMs that are enabled for migration between VMMs. In one embodiment, the method 1400 begins with receiving a source configuration and a target configuration of the highly available system as input (1401). A configuration change is generated, which disables migration of the VMs that are to be added, modified and removed in the upgrade campaign (1402). The migration is disabled when each of the VMs is anchored on a hosting VMM selected from the input. Then a first set, a second set and a third set of sub-trees are identified from tree views of the source configuration and the target configuration (1403). Each sub-tree contains entities representing a subset of the VMs and the VMMs. Each sub-tree of the first set includes entities tagged for addition only, each sub-tree of the second set includes entities tagged for modification, and each sub-tree of the third set includes entities tagged for removal only. The method 1400 proceeds to generate an upgrade procedure for each sub-tree of the first set, the second set and the third set, with an indication that upgrade procedures of the first set are to be executed first and upgrade procedures for the third set are to be executed last in the upgrade campaign (1404). Then the method 1400 proceeds to generate another configuration change that re-enables the migration of the VMs according to the target configuration (1405).

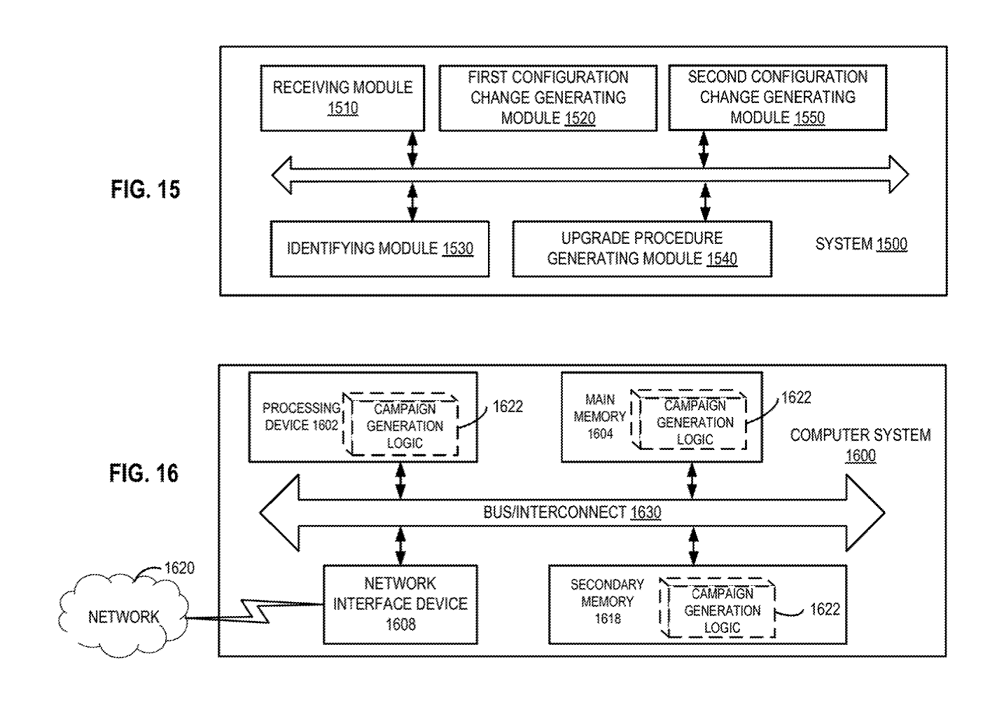

The method 1400 may be performed by hardware (e.g., circuitry, dedicated logic, programmable logic, microcode, etc.), software (e.g., instructions run on a processing device), or a combination thereof. In one embodiment, the method 1400 may be performed by a system 1500 of FIG. 15 and/or by a computer system 1600 of FIG. 16.

FIG. 15 illustrates an upgrade campaign generator system 1500 for generating an upgrade campaign for runtime execution on a highly available system according to one embodiment. In one embodiment, the system 1500 is coupled to the highly available system, generates the upgrade campaign offline or at runtime of the highly available system, and then provides the upgrade campaign to the highly available system for runtime execution. In an alternative embodiment, the system 1500 may be the highly available system. The highly available system (that is, the system that is to execute the resulting upgrade campaign) includes VMs that are enabled for migration between VMMs. In one embodiment, the system 1500 performs the method 1400 of FIG. 14.

The system 1500 comprises a receiving module 1510 configured to receive a source configuration and a target configuration of the highly available system as input; a first configuration change generating module 1520 configured to generate a configuration change that disables the migration of the VMs that are to be added, modified and removed in the upgrade campaign. The migration is disabled when each of the VMs is anchored on a hosting VMM selected from the input; and an identifying module 1530 configured to identify a first set, a second set and a third set of sub-trees from tree views of the source configuration and the target configuration. Each sub-tree contains entities representing a subset of the VMs and the VMMs. Each sub-tree of the first set includes entities tagged for addition only, each sub-tree of the second set includes entities tagged for modification, and each sub-tree of the third set includes entities tagged for removal only. The system 1500 further comprises an upgrade procedure generating module 1540 configured to generate an upgrade procedure for each sub-tree of the first set, the second set and the third set, with an indication that upgrade procedures of the first set are to be executed first and upgrade procedures for the third set are to be executed last in the upgrade campaign. The system 1500 further comprises a second configuration change generating module 1550 configured to generate another configuration change that re-enables the migration of the VMs according to the target configuration.

FIG. 16 illustrates a diagrammatic representation of a machine in the exemplary form of the computer system 1600 within which a set of instructions, for causing the machine to perform any one or more of the methodologies discussed herein, may be executed. In one embodiment, the computer system 1600 may be part of a network node (e.g., a router, switch, bridge, controller, base station, etc.). In one embodiment, the computer system 1600 may operate in a cloud computing environment where multiple server computers in one or more service centers collectively provide computing services on demand. The computer system 1600 may be a server computer, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The computer system 1600 includes a processing device 1602. The processing device 1602 represents one or more general-purpose processors, each of which can be: a microprocessor, a central processing unit (CPU), a multicore system, or the like. The processing device 1602 may also be one or more special-purpose processing devices such as an application specific integrated circuit (ASIC), a field programmable gate array (FPGA), a digital signal processor (DSP), network processor, or the like. In one embodiment, the processing device 1602 is adapted or operative to execute the operations of a campaign generation logic 1622 which contains instructions executable by the processing device 1602 to perform the method 600 of FIG. 6, the method 1400 of FIG. 14 and the upgrade procedure generation processes 1100, 1200 and 1300 of FIGS. 11-13. In one embodiment, the processing device 1602 may host a set of virtual machines adapted to execute the operations of the campaign generation logic 1622.

In one embodiment, the processor device 1602 is coupled to one or more memory devices such as: a main memory 1604 (e.g., read-only memory (ROM), flash memory, dynamic random access memory (DRAM), etc.), a secondary memory 1618 (e.g., a magnetic data storage device, an optical magnetic data storage device, etc.), and other forms of computer-readable media, which communicate with each other via a bus or interconnect 1630. The memory devices may also include different forms of read-only memories (ROMs), different forms of random access memories (RAMs), static random access memory (SRAM), or any type of media suitable for storing electronic instructions. In one embodiment, the memory devices may store the code and data of the campaign generation logic 1622. In the embodiment of FIG. 16, the campaign generation logic 1622 may be located in one or more of the locations shown as dotted boxes and labeled by the reference numeral 1622. In alternative embodiments the campaign generation logic 1622 may be located in other location(s) not shown in FIG. 16.

In one embodiment, the computer system 1600 is adapted or operative to perform the method 1400 of FIG. 14 for generating an upgrade campaign for runtime execution on a highly available system where the highly available system includes VMs that are enabled for migration between VMMs. In one embodiment, the one or more memory devices of the computer system 1600 store a source configuration and a target configuration of the highly available system. The processing device 1602, having one or more processors coupled to the memory devices, is adapted or operative to receive the source configuration and the target configuration as input; and generate a configuration change that disables migration of the VMs to be added, modified and removed in the upgrade campaign, where the migration is disabled when each of the VMs is anchored on a hosting VMM selected from the input. The processing device 1602 is further adapted or operative to identify a first set, a second set and a third set of sub-trees from tree views of the source configuration and the target configuration, where each sub-tree contains entities representing a subset of the VMs and the VMMs, and where each sub-tree of the first set includes entities tagged for addition only, each sub-tree of the second set includes entities tagged for modification, and each sub-tree of the third set includes entities tagged for removal only. The processing device 1602 is further adapted or operative to generate an upgrade procedure for each sub-tree of the first set, the second set and the third set, with an indication that upgrade procedures of the first set are to be executed first and upgrade procedures for the third set are to be executed last in the upgrade campaign; and generate another configuration change that re-enables the migration of the VMs according to the target configuration.

The computer system 1600 may further include a network interface device 1608. A part or all of the data and code of the campaign generation logic 1622 may be transmitted or received over a network 1620 via the network interface device 1608.

In one embodiment, the campaign generation logic 1622 can be implemented using code and data stored and executed on one or more computer systems (e.g., the computer system 1600). Such computer systems store and transmit (internally and/or with other electronic devices over a network) code (composed of software instructions) and data using computer-readable media, such as non-transitory tangible computer-readable media (e.g., computer-readable storage media such as magnetic disks; optical disks; read only memory; flash memory) and transitory computer-readable transmission media (e.g., electrical, optical, acoustical or other form of propagated signals—such as carrier waves, infrared signals). A non-transitory computer-readable medium of a given computer system typically stores instructions for execution on one or more processors of that computer system.

The operations of the flow diagrams of FIGS. 6 and 11-14 have been described with reference to the exemplary embodiments of FIGS. 15 and 16. However, it should be understood that the operations of the flow diagrams of FIGS. 6 and 11-14 can be performed by embodiments of the invention other than those discussed with reference to FIGS. 15 and 16, and the embodiments discussed with reference to FIGS. 15 and 16 can perform operations different than those discussed with reference to the flow diagrams. While the flow diagrams of FIGS. 6 and 11-14 show a particular order of operations performed by certain embodiments of the invention, it should be understood that such order is exemplary (e.g., alternative embodiments may perform the operations in a different order, combine certain operations, overlap certain operations, etc.).

It is to be understood that the above description is intended to be illustrative, and not restrictive. Many other embodiments will be apparent to those of skill in the art upon reading and understanding the above description. Accordingly, the specification and drawings are to be regarded in an illustrative sense rather than a restrictive sense.

1. A method performed by a computer system for generating an upgrade campaign for runtime execution on a highly available system, wherein the highly available system includes virtual machines (VMs) that are enabled for migration between virtual machine monitors (VMMs), the method comprising the steps of:
identifying differences between a source configuration and a target configuration of the highly available system;
generating a configuration change, for each of a plurality of migration enabled VMs, that disables migration of the VM and anchors the VM to a VMM selected from the input configuration;
identifying a first set of sub-trees from a tree view of the target configuration, wherein each sub-tree of the first set includes entities tagged for addition in the target configuration;
identifying a second set of sub-trees from a tree view of the source configuration and the tree view of the target configurations, wherein each sub-tree of the second set includes entities tagged for modification in the source and target configurations;
identifying a third set of sub-trees from a tree view of the source configuration, wherein each sub-tree of the third set includes entities tagged for removal in the target configuration;
generating the upgrade campaign including an upgrade procedure for each sub-tree of the first, second and third sets, with an indication that upgrade procedures for sub-trees of the first set are to be executed first and upgrade procedures for sub-trees of the third set are to be executed last in the upgrade campaign; and
generating another configuration change that enables the migration of the VMs according to the target configuration wherein each VM is associated with a VMM eligible for hosting the VM according to a dependency object, thereby enabling execution of the upgrade campaign.

2. The method of claim 1, wherein no parent nodes of the sub-trees of the first set are tagged for addition, and no parent nodes of the sub-trees of the third set are tagged for removal.

3. The method of claim 1, wherein each sub-tree of the second set has a root that is tagged for modification, and all parent nodes of the root are tagged for no operation.

4. The method of claim 1, wherein the step of generating the upgrade procedure further comprises the step of:
generating a first single-step upgrade procedure for each sub-tree of the first set to form a set of first single-step upgrade procedures, wherein the set of first single-step upgrade procedures are set to one or more first execution levels to indicate that the set of first single-step upgrade procedures are to be executed first among all upgrade procedures in the upgrade campaign.

5. The method of claim 4, wherein the step of generating the first single-step upgrade procedure further comprises the step of:
generating a second single-step upgrade procedure for each sub-tree of the second set to form a set of second single-step upgrade procedures, wherein the set of second single-step upgrade procedures are set to sequential execution levels to indicate that the set of second single-step upgrade procedures are to be executed sequentially after the set of first single-step upgrade procedures.

6. The method of claim 5, wherein the step of generating the second single-step upgrade procedure further comprises the step of:
generating a third single-step upgrade procedure for each sub-tree of the third set to form a set of third single-step upgrade procedures, wherein the set of third single-step upgrade procedures are set to one or more third execution levels to indicate that the set of third single-step upgrade procedures are to be executed after the set of second single-step upgrade procedures.

7. The method of claim 1, wherein the step of generating a configuration change that disables migration of the VMs further comprises the steps of:
selecting a first hosting VMM that is present in the target configuration for a to-be-added VM;
selecting a second hosting VMM that is present in both the source configuration and the target configuration for a to-be-modified VM; and
selecting a third hosting VMM that is present in the source configuration for a to-be-removed VM.

8. The method of claim 1, wherein each of the entities in the sub-trees is an execution environment (EE) entity defined in Platform Management (PLM) services.

9. The method of claim 1, wherein the step of generating a configuration change that disables migration of the VMs further comprises the step of:
generating a modification operation for the dependency object of each entity in the sub-trees that represents a VM and is tagged for removal or modification, such that the dependency object contains a single hosting VMM for the VM.

10. The method of claim 1, wherein the step of generating another configuration change that enables the migration of the VMs further comprises the step of:
generating a modification operation for the dependency object of each entity in the sub-trees that represents a VM and is tagged for addition or modification, such that the dependency object contains a complete list of eligible hosting VMMs for the VM.

11. The method of claim 1, wherein each upgrade procedure is a single-step upgrade procedure that contains one or more nested steps, each of the nested steps including a sequence of actions for upgrading a layer of the entities in the sub-trees.

12. A system adapted to generate an upgrade campaign for runtime execution on a highly available system, wherein the highly available system includes virtual machines (VMs) that are enabled for migration between virtual machine monitors (VMMs), the system comprising:
a memory to store a source configuration and a target configuration of the highly available system; and
one or more processors coupled to the memory, the one or more processors adapted to:
identify differences between the source configuration and the target configuration;
generate a configuration change, for each of a plurality of migration enabled VMs, that disables migration of the VM and anchors the VM to a VMM selected from the input configuration;
identify a first set of sub-trees from a tree view of the target configuration, wherein each sub-tree of the first set includes entities tagged for addition in the target configuration;
identify a second set of sub-trees from a tree view of the source configuration and the tree view of the target configurations, wherein each sub-tree of the second set includes entities tagged for modification in the source and target configurations;
identify a third set of sub-trees from a tree view of the source configuration, wherein each sub-tree of the third set includes entities tagged for removal in the target configuration;
generate the upgrade campaign including an upgrade procedure for each sub-tree of the first, second and third sets, with an indication that upgrade procedures for sub-trees of the first set are to be executed first and upgrade procedures for sub-trees of the third set are to be executed last in the upgrade campaign; and
generate another configuration change that enables the migration of the VMs according to the target configuration wherein each VM is associated with a VMM eligible for hosting the VM according to a dependency object, thereby enabling execution of the upgrade campaign.

13. The system of claim 12, wherein no parent nodes of the sub-trees of the first set are tagged for addition, and no parent nodes of the sub-trees of the third set are tagged for removal.

14. The system of claim 12, wherein each sub-tree of the second set has a root that is tagged for modification, and all parent nodes of the root are tagged for no operation.

15. The system of claim 12, wherein, when generating the upgrade procedure, the one or more processors are further adapted to:
generate a first single-step upgrade procedure for each sub-tree of the first set to form a set of first single-step upgrade procedures, wherein the set of first single-step upgrade procedures are set to one or more first execution levels to indicate that the set of first single-step upgrade procedures are to be executed first among all upgrade procedures in the upgrade campaign.

16. The system of claim 15, wherein, when generating the upgrade procedure, the one or more processors are further adapted to:
generate a second single-step upgrade procedure for each sub-tree of the second set to form a set of second single-step upgrade procedures, wherein the set of second single-step upgrade procedures are set to sequential execution levels to indicate that the set of second single-step upgrade procedures are to be executed sequentially after the set of first single-step upgrade procedures.

17. The system of claim 16, wherein, when generating the upgrade procedure, the one or more processors are further adapted to:
generate a third single-step upgrade procedure for each sub-tree of the third set to form a set of third single-step upgrade procedures, wherein the set of third single-step upgrade procedures are set to one or more third execution levels to indicate that the set of third single-step upgrade procedures are to be executed after the set of second single-step upgrade procedures.

18. The system of claim 12, wherein, when generating the configuration change that disables migration of the VMs, the one or more processors are further adapted to:
select a first hosting VMM that is present in the target configuration for a to-be-added VM;
select a second hosting VMM that is present in both the source configuration and the target configuration for a to-be-modified VM; and
select a third hosting VMM that is present in the source configuration for a to-be-removed VM.

19. The system of claim 12, wherein each of the entities in the sub-trees is an execution environment (EE) entity defined in Platform Management (PLM) services.

20. The system of claim 12, wherein, when generating the configuration change that disables migration of the VMs, the one or more processors are further adapted to:
generate a modification operation for the dependency object of each entity in the sub-trees that represents a VM and is tagged for removal or modification, such that the dependency object contains a single hosting VMM for the VM.

21. The system of claim 12, wherein, when generating the other configuration change that enables the migration of the VMs, the one or more processors are further adapted to:
generate a modification operation for the dependency object of each entity in the sub-trees that represents a VM and is tagged for addition or modification, such that the dependency object contains a complete list of eligible hosting VMMs for the VM.

22. The system of claim 12, wherein each upgrade procedure is a single-step upgrade procedure that contains one or more nested steps, each of the nested steps including a sequence of actions for upgrading a layer of the entities in the sub-trees.

23. (canceled)
